(19) United States
(12) Patent Application Publication
(10) Pub. No.: US 2005/0146475 A1
(43) Pub. Date: Jul. 7, 2005

(54) Slot antenna configuration

(76) Inventors: Allen W. Bettner, Los Gatos, CA (US); Xintian E. Lin, Palo Alto, CA (US); Alan E. Waltho, San Jose, CA (US); Qinghua Li, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/750,557

(22) Filed: Dec. 31, 2003

(51) Int. Cl. H01Q 13/10; H01Q 1/24

(52) U.S. Cl. 343/767; 343/702

(57) ABSTRACT

The skin of a computing device comprises a conductive material. A slot is included in the skin to form a slot antenna. Various embodiments of the slot antenna can support multiple frequency bands with a single slot and provide directional propagation patterns.

### FIELD OF THE INVENTION

The present invention relates to the field of wireless communications. More specifically, the present invention relates to a slot antenna configuration.

### BACKGROUND

Wireless communications are a driving force in the electronics industry. Wireless connections are widely used for computer networking, peripheral devices, and the like. Antennas are an integral part of all wireless communications. The amount of data that a wireless connection can carry, as well as the distance and the coverage of a wireless connection, often depend in large part on the size, type, and configuration of the antenna(s) being used. Larger antennas tend to provide better connectivity, but large antennas can be inconvenient, fragile, and unsightly. Furthermore, the form factors of many electronic devices do not readily accommodate large or fragile antennas.

Notebook computers provide a good example of the design challenges for antennas. Wireless networking is increasingly popular among notebook computer users. Notebook computers, however, are often compact, leaving limited room for an antenna. Durability is also quite important because notebook computers are frequently moved, packed away and pulled out of bags or carrying cases, used in cramped quarters, and the like. External housings are often made of metal to improve durability, but metal can interfere with, or shield, an antenna. This shielding makes an internal antenna especially difficult to implement. Attaching an antenna flush against a metal surface can also be problematic. A protruding antenna, on the other hand, can be vulnerable to damage, not to mention unsightly.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of slot antennas on a notebook computer.

FIG. 2 illustrates one embodiment of a slot antenna.

FIG. 3 illustrates one embodiment of an E-plane propagation pattern for a slot antenna.

FIG. 4 illustrates one embodiment of a one-sided slot antenna backed by a quarter-wavelength cavity.

FIG. 5 illustrates one embodiment of a one-sided slot antenna backed by an Artificial Magnetic Conductor (AMC).

FIG. 6 illustrates one embodiment of double slot antenna.

FIG. 7 illustrates one embodiment of a return-loss curve for a slot antenna.

FIG. 8 illustrates one embodiment of tunable slot antenna characteristics.

FIG. 9 illustrates one embodiment of a computer tablet using slot antennas.

### DETAILED DESCRIPTION OF THE INVENTION

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail. Parts of the description will be presented using terminology commonly employed by those skilled in the art to convey the substance of their work to others skilled in the art. Repeated usage of the phrase “in one embodiment” does not necessarily refer to the same embodiment, although it may.

Embodiments of the present invention include various configurations of slot antennas that can be formed in the conductive skin used on a wide variety of computing devices. Embodiments of the inventive slot antennas can provide a host of advantages compared to most other external antenna configurations. For example, the slot antennas can be durable and very low profile because they are essentially part of the surface of computing devices which use them. Depending on fill materials and color schemes, the slot antennas can also be virtually invisible to a user. Adding a slot antenna can actually reduce the weight of a computing device by removing a portion of the skin. A slot antenna can also be comparatively simple to add to a computing device by just removing a slot in the skin, and can therefore be quite cost effective.

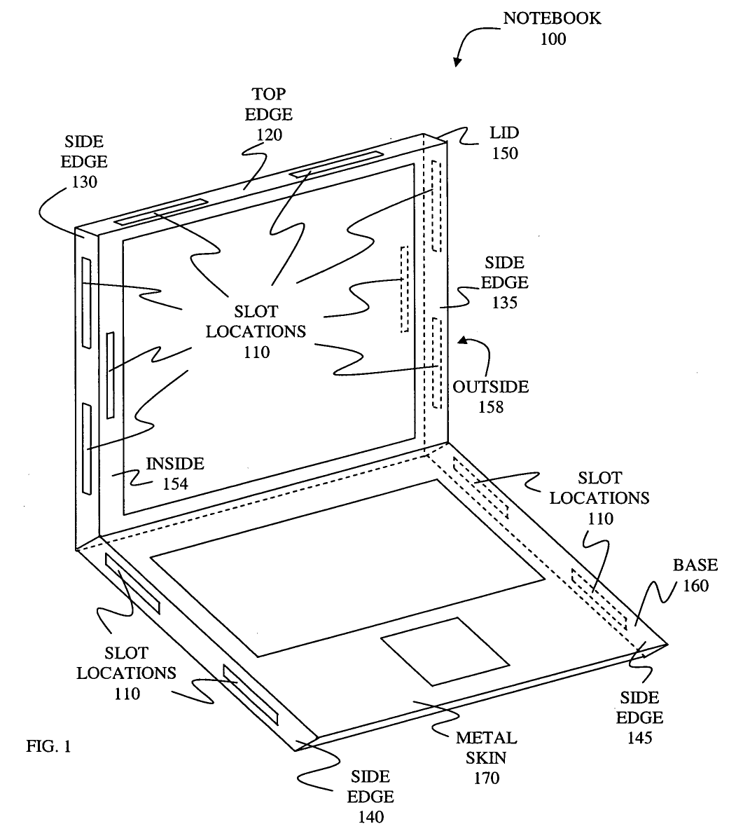

FIG. 1 illustrates one embodiment of a notebook computer 100 with a conductive metal skin 170. Slot antennas can be cut, or otherwise formed, in virtually any surface of notebook 100 that is covered by conductive skin 170. FIG. 1 shows a few potential slot locations 110, including slot locations along a top edge 120, side edges 130 and 135, inside 154, and outside 158 of lid 150, as well as side edges 140 and 145 of base 160.

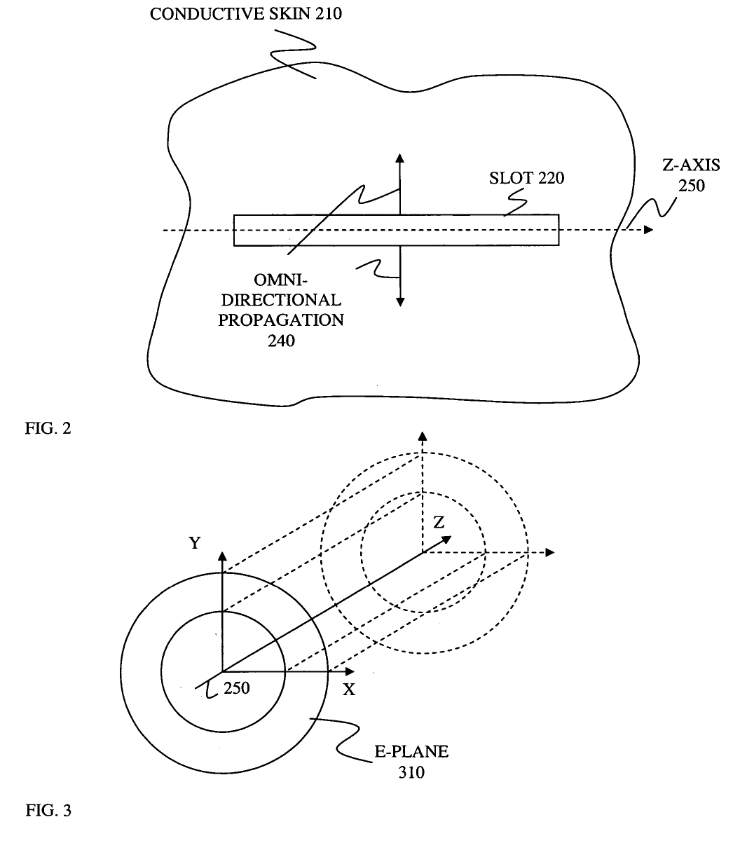

FIG. 2 illustrates one embodiment of a slot antenna that could be used, for instance, in any of the slot locations 110 in FIG. 1. A slot 220 is formed in a conductive skin 210. Slot 220 can simply be an opening in skin 210. Alternatively, slot 220 can be filed with an insulator material. Any number of approaches can be used to form the slot.

Conductive skin 210 can be any number of materials or combinations of materials. For example, in one embodiment, conductive skin 210 comprises a sheet of metal. In another embodiment, conductive skin 210 may comprise a sheet of plastic with a conductive coating or mesh. In which case, the conductive coating or mesh may not cover the entire skin, but instead may be located merely in the vicinity of the slot 220.

If the z-axis 250 of an x, y, z coordinate system is aligned with the long dimension of slot 220 as shown in FIG. 2, the propagation pattern 240 of an ideal electric field generated by the slot antenna can be omni-directional in the xy plane. That is, as shown in FIG. 3, an ideal E-plane pattern 310 generated by a slot antenna in an infinite conductive plane may form a donut-like propagation pattern that uniformly radiates out from the z-axis 250 in all directions of the xy plane. In the direction of the Z-axis 250, the ideal radiation pattern may be zero.

In practice, the radiation pattern from a slot antenna in the conductive skin of a computing device is unlikely to be the same as the ideal pattern shown in FIG. 3. For instance, shielding, interference, and/or obstructions from the internal workings of the computing device itself, as well as the finite dimension of the conductive skin, can affect the pattern. Embodiments of the present invention can change the propagation pattern to accommodate for the changes and/or to provide a variety of advantageous features.

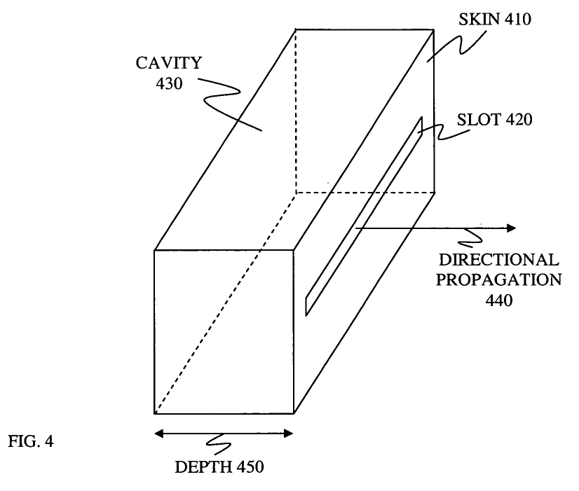

For example, FIG. 4 illustrates one embodiment of a “one-sided” slot antenna, also called a sector slot antenna. A sector antenna is directional. In other words, the radiation pattern of a sector antenna is designed to transmit and/or receive a signal in a particular direction with respect to the antenna. Compared to an omni-directional antenna, a sector antenna can provide superior connectivity for signals within its radiation pattern.

In FIG. 4, a cavity 430 can be formed behind slot 420 in skin 410. The cavity surfaces may be a conductive material similar to the material used for skin 410. The cavity may simply be air-filled, or it may be filled with any of a variety of materials.

The slot antenna is “one-sided” in that a portion of the E-plane pattern that is radiated into cavity 430 can be reflected back out slot 420. By selecting an appropriate depth 450 for the cavity, the reflected portion can constructively interfere with a portion of the E-plane pattern already radiating away from cavity 430. The constructive interference can intensify the directional propagation pattern 440, substantially improving the antenna's performance in the direction of the propagation.

An appropriate depth 450 for cavity 430 is usually about one-quarter of a wavelength of a resonant frequency for the slot antenna. Some typical frequency bands used by various wireless communications standards include 2.4 GHz and 5 GHz. In which case, an appropriate quarter-wavelength cavity depth would be about 3 cm for 2.4 GHz, and about 1.5 cm for 5 GHz. If the cavity is filled with a dielectric material, the depth can be reduced to some extent.

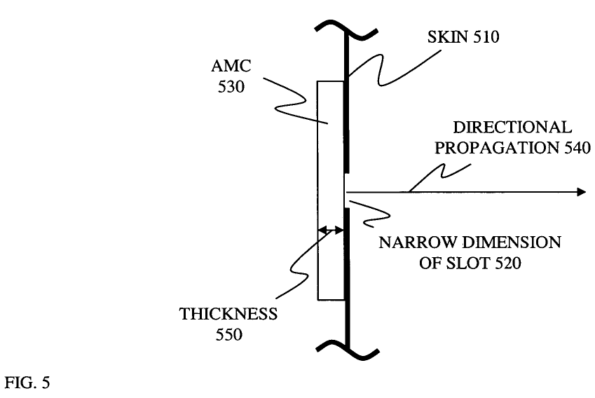

Cavity depths of several centimeters may not be practical in certain computing devices. FIG. 5 illustrates one embodiment of a sector slot antenna that does not use a cavity. Instead of a cavity behind slot 520 in skin 510, an Artificial Magnetic Conductor (AMC) 530 can be used to reflect a portion of the E-plane pattern to create a directional propagation pattern 540.

AMC is a type of impedance plane that is usually made from layers of printed circuit board (PCB) material comprising metal patches, vias (holes), and dielectric material, giving it a planar form factor. The thickness 550 of AMC 530 can be considerably smaller than the depth 450 of cavity 430. In many situations, AMC can be made less than 3 millimeters thick.

AMC is designed to approximate a perfect magnetic conductor to reflect signals in at least one particular frequency band. That is, a single-band AMC material can approximate a perfect magnetic conductor in one frequency band, and a dual-band AMC material can approximate a perfect magnetic conductor in two frequency bands. So, for instance, AMC 530 can be used to reflect one or more frequency bands into directional propagation pattern 540. Other embodiments may use other types of impedance plane materials to reflect a portion of the E-plane pattern.

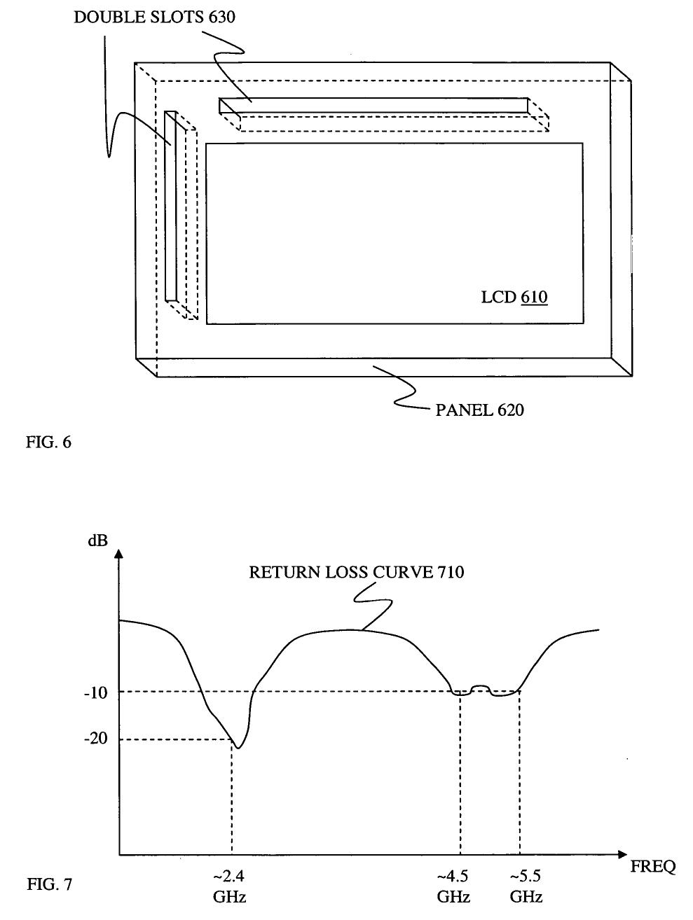

FIG. 6 illustrates another embodiment of the inventive slot antenna. Rather than forming a slot through just one layer of skin, double slots 630 extend entirely through panel 620, passing through the skin both in the front and back. In which case, each of the doubled sided slots 630 can have a radiation pattern both to the front and back of the panel.

In the illustrated embodiment, panel 630 could be the lid of a notebook computer or other computer device, housing a liquid crystal display (LCD) 610. In other embodiments, panel 630 could be a computer tablet, a personal data assistant (PDA), the base of a notebook computer, and the like.

Other embodiments may include just one double slot or more than two double slots. The slots can be placed in any number of position. In some embodiments, the slots can be left entirely open and in other embodiments the slots can be filled with any number of materials. A single feed line can be used to drive both sides of a double slot, or a pair of feed lines-can be used.

In addition to altering the propagation pattern, various embodiments of the present invention can be tuned to resonant at multiple frequency bands. For instance, FIG. 7 illustrates an approximation of an experimental return-loss curve 710 generated using one embodiment of the inventive slot antenna. Curve 710 shows sufficient antenna performance for a primary frequency at approximately 2.4 GHz and a secondary resonant frequency between about 4.5 GHz and 5.5 GHz. One or both frequency bands are commonly used by a variety of wireless communications standards, such as Bluetooth, and the family of IEEE 802.11a, b, and g wireless local area networks (WLAN). In other words, embodiments of the inventive slot antenna can be tuned to simultaneously support two frequency bands, and/or two wireless communications standards, using a single antenna, eliminating the need for separate antennas for different frequency bands.

Furthermore, the single antenna can be made into a dual-band, sector antenna using, for instance, a dual-band AMC, as described in FIG. 5. That is, embodiments of the present invention can provide the same or similar directional propagation patterns simultaneously for multiple frequency bands.

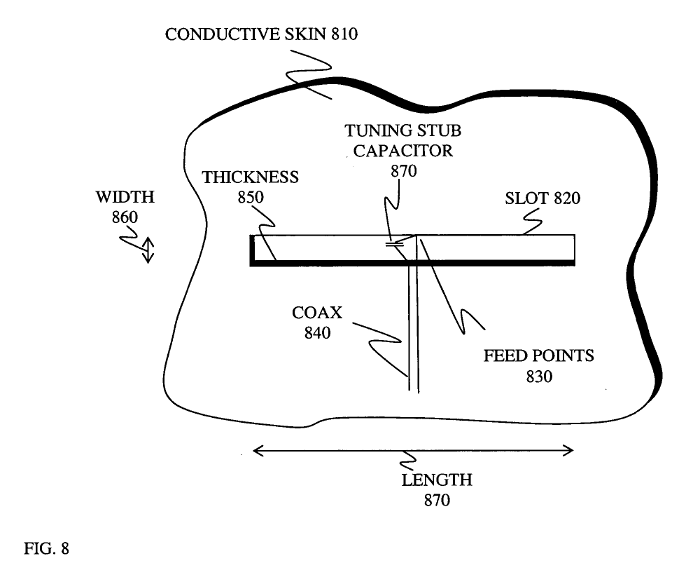

FIG. 8 illustrates one embodiment of a number of slot characteristics that can be added, removed, and/or adjusted (tuned) to support various resonant frequencies, as well as change impedance characteristics of the inventive slot antennas. Slot 820 in skin 810 has a thickness 850, a width 860, and a length 870. Feed points 830 couple a feeder (coaxial line 840 in the illustrated embodiment) to opposite edges of slot 820 to drive a signal onto the antenna and/or receive a signal from the antenna. A tuning element (tuning stub capacitor 870 in the illustrated embodiment) can also be added to one or both of the feed points 830.

The thickness 850 can be changed by, for instance, adding or removing a conductive coatings or meshes in the vicinity of slot 820, or by changing the thickness of skin 810. Width 860 and length 870 can be changed by forming a larger or smaller opening in the skin. The amount of the capacitance of stub capacitor 870 can be increased or decreased. In one embodiment, stub capacitor 870 comprises a piece of copper foil, and the capacitance can be changed by changing the size of the copper foil.

For example, the return-loss curve 710 from FIG. 7 was based on a slot thickness of about 0.03 mm, a width of about 1.8 mm, and a length of about 88 mm, with a piece of copper foil near one of the feed points at approximately the center of one edge of the slot. This configuration produced an unexpectedly low impedance, quite close to the 50 ohm impedance needed to match many radio frequency components and well below the theoretical impedance of almost 500 ohms. By manipulating these characteristics, a wide variety of impedances can be achieved. In other words, the skin of the computing device itself can be used to create an impedance matching circuit to match the antenna to a signal source, which can be a significant simplification and cost savings. By changing the capacitance, a variety of secondary, or upper, frequency bands could also be tuned.

Various embodiments of the present invention can use multiple slot antennas in combination. For example, referring back to FIG. 1, notebook computer 100 may include one or more slot antennas on edges 130 and 135 with propagation patterns radiating to the front and back of the notebook to provide coverage nearly 360 degrees around the computer. In another embodiment, notebook 100 could include four sector antennas, such as the ones described in FIGS. 4 and/or 5, each pointing in a different direction to provide a sector antenna array for superior sectorized coverage.

In yet another embodiment, notebook 100 could include two or more antennas with overlapping propagation patterns to provide antenna diversity. That is, notebook 100 could use two or more antennas to receive the same signal or signals simultaneously. Antenna diversity can provide a number of advantages over a single antenna, such as noise cancellation by combining signals from two or more antennas, or simply selecting the antenna that has better performance at any given time.

For example, notebook 100 could include an array of eight sector slot antennas that together comprise a diversity antenna system. The outside 158 of lid 150 could include a horizontally oriented sector slot antenna and a vertically oriented sector slot antenna. Similarly, the inside 154 of lid 150 could include horizontal and vertical sector antennas. A sector slot antenna could be included in each of edges 130, 135, 140, and 145 so that when lid 150 is opened, the edge-mounted antennas would provide pairs of vertically and horizontally oriented antennas on each side. Then, the computer could select the best performing antenna from among the eight antennas at any given time, and/or combine signals from two or more antennas if, for instance, no single antenna's performance was adequate.

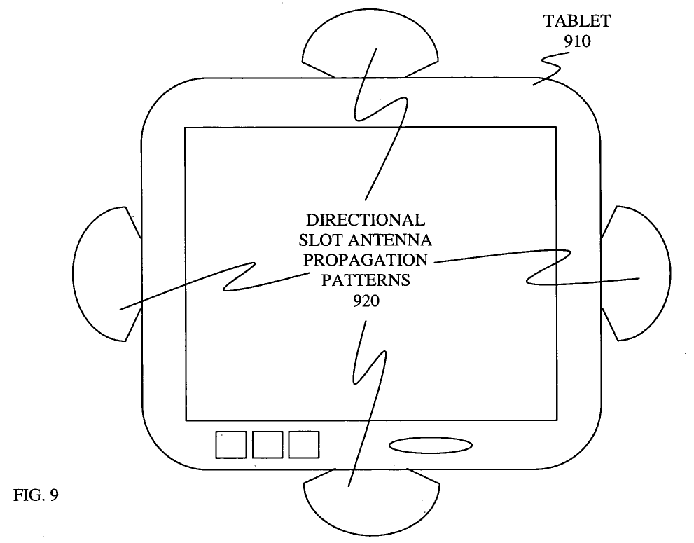

Although the present invention has primarily been described in the context of a notebook computer, embodiments of the present invention can be used in a wide variety of computing devices with conductive skins, such as computer tablets, hand-held or palm-top devices, and the like. For example, FIG. 9 illustrates one embodiment of a computer tablet 910 that has directional slot antenna propagation patterns 920 radiating out from all four edges of the tablet.

Other embodiments of the present invention may use any number of antennas in any number of combinations and locations on a computer device. Other embodiments may also combine slot antennas with other types of antennas, such as di-poles, mono-poles, Yagi antennas, and the like.

Thus, a slot antenna configuration is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

1. An apparatus comprising:
a skin of a computing device, said skin comprising a conductive material; and
a slot in the skin, said slot comprising a slot antenna.

2. The apparatus of claim 1 wherein the conductive material comprises an outer layer of the skin in at least of vicinity of the slot.

3. The apparatus of claim 2 wherein the outer layer comprises one of a conductive coating and a conductive mesh.

4. The apparatus of claim 2 wherein the slot extends through only the outer layer.

5. The apparatus of claim 2 wherein the slot extends through both the skin and the conductive layer.

6. The apparatus of claim 1 wherein the skin is made entirely of the conductive material.

7. The apparatus of claim 1 wherein the computing device comprises one of a notebook computer, a tablet computer, and a handheld computer.

8. The apparatus of claim 1 wherein the computing device comprises at least one of a base and a lid, and wherein the slot is located in at least one of an edge of the base, an edge of the lid, an outside of the lid, an inside of the lid, through the lid, and through the base.

9. The apparatus of claim 1 further comprising:
a cavity behind the slot, said cavity having a depth of approximately one-quarter of a wavelength of a resonant frequency of the slot antenna.

10. The apparatus of claim 1 further comprising:
an impedance plane coupled to the skin under the slot.

11. The apparatus of claim 10 wherein the impedance plane comprises an Artificial Magnetic Conductor (AMC).

12. The apparatus of claim 10 wherein the impedance plane comprises a multiple band impedance plane, said multiple band impedance plane to act as a magnetic conductor for a primary resonant frequency and a secondary resonant frequency of the slot.

13. The apparatus of claim 1 wherein the slot antenna has a primary resonant frequency and a secondary resonant frequency.

14. The apparatus of claim 13 wherein the primary resonant frequency and the secondary resonant frequency are tuned for two different wireless communications standards.

15. The apparatus of claim 14 wherein the two wireless communications standards comprise at least one of Bluetooth, 802.11a, 802.11b, and 802.11g.

16. The apparatus of claim 1 wherein at least one of a thickness of the skin in a vicinity of the slot, a width of the slot, a length of the slot, and a tuning element at a feed point of the slot are tuned to achieve at least one of a target impedance and a primary resonant frequency of the slot.

17. The apparatus of claim 1 wherein the slot antenna comprises a sector slot antenna having a directional radiation pattern.

18. The apparatus of claim 17 wherein the sector slot antenna comprises a first sector slot antenna in a sector antenna system, said sector antenna system further comprising:
a second sector slot antenna in the skin, said second sector slot antenna having a directional radiation pattern in a different direction than the first sector slot antenna.

19. The apparatus of claim 17 wherein the sector slot antenna comprises a first sector slot antenna in a sector antenna system, the apparatus further comprising:
a plurality of additional sector slot antennas in the skin, each of the plurality of additional sector slot antennas having a directional radiation pattern coving a different sector surrounding the computing device.

20. The apparatus of claim 17 wherein the sector slot antenna has the directional radiation pattern for multiple resonant frequency bands.

21. The apparatus of claim 1 further comprising:
a tuning element coupled to the slot, said tuning element to tune a secondary frequency for the slot antenna.

22. The apparatus of claim 21 wherein the tuning element comprises a stub capacitor.

23. The apparatus of claim 1 wherein the slot antenna comprises a first slot antenna, the apparatus further comprising:
a second slot antenna in the skin, said first slot antenna and said second slot antenna comprising a diversity antenna.

24. A system comprising:
a notebook computer;
a skin covering at least a portion of the notebook computer, said skin comprising a conductive material; and
a slot in the skin, said slot comprising a slot antenna.

25. The system of claim 24 further comprising:
a cavity behind the slot, said cavity having a depth of approximately one-quarter of a wavelength of a resonant frequency of the slot antenna.

26. The system of claim 24 further comprising:
an impedance plane coupled to the skin under the slot.

27. The system of claim 26 wherein the impedance plane comprises an Artificial Magnetic Conductor (AMC).

28. The system of claim 24 wherein the slot antenna comprises a sector slot antenna having a directional radiation pattern.

29. The system of claim 28 wherein the sector slot antenna comprises a first sector slot antenna in a sector antenna system, said sector antenna system further comprising:
a second sector slot antenna in the skin, said second sector slot antenna having a directional radiation pattern in a different direction than the first sector slot antenna.

30. The system of claim 28 wherein the sector slot antenna comprises a first sector slot antenna in a sector antenna system, the apparatus further comprising:
a plurality of additional sector slot antennas in the skin, each of the plurality of additional sector slot antennas having a directional radiation pattern coving a different sector surrounding the notebook computer.

31. The system of claim 24 wherein the slot antenna comprises a first slot antenna, the apparatus further comprising:
a second slot antenna in the skin, said first slot antenna and said second slot antenna comprising a diversity antenna.

32. An apparatus comprising:
a skin of a computing device, said skin comprising a conductive material;
a first slot in the skin, said first slot comprising a first sector slot antenna having a radiation pattern in a first direction;
a second slot in the skin, said second slot comprising a second sector slot antenna having a radiation pattern in a second direction;
a third slot in the skin, said third slot comprising a third sector slot antenna having a radiation pattern in a third direction; and
a fourth slot in the skin, said fourth slot comprising a fourth sector slot antenna having a radiation pattern in a fourth direction.

33. The apparatus of claim 32 wherein the first, second, third, and fourth sector slot antennas have a primary resonant frequency and a secondary resonant frequency tuned for two different wireless communications standards.
